(19) United States
(12) Patent Application Publication
(10) Pub. No.: US 2014/0011766 A1
(43) Pub. Date: Jan. 9, 2014

(54) ANTIMICROBIAL COMPOSITIONS AND METHODS

(71) Applicant: RANDALL W. KRAFFT, TAMPA, FL (US)

(72) Inventor: RANDALL W. KRAFFT, TAMPA, FL (US)

(21) Appl. No.: 14/024,333

(22) Filed: Sep. 11, 2013

Related U.S. Application Data
(63) Continuation-in-part of application No. 13/357,122, filed on Jan. 24, 2012.

(51) Int. Cl. A01N 55/00

(52) U.S. Cl. CPC A01N 55/00
USPC 514/63

(57) ABSTRACT

Methods and compositions to reduce the rate of infections in a hospital wherein a long-acting surface disinfectant is applied to pre-cleaned hard surfaces in the hospital and wherein health care workers apply a persistent hand sanitizer to their hands. The long-acting surface disinfectant contains an antimicrobial organosilane compound and an additive. The persistent hand sanitizer contains an antimicrobial agent and a treated particle.

### BACKGROUND OF THE INVENTION

1. Related Application

The present non-provisional application is based upon pending patent application Ser. No. 13/357,122 filed Jan. 24, 2012, the subject matter of which is incorporated herein by reference.

2. Field of the Invention

The present invention relates to antimicrobial compositions and methods and more particularly pertains to persistently disinfecting surfaces and persistently sanitizing hands with compositions containing organosilane compounds.

3. Description of the Prior Art

The use of disinfecting and sanitizing compounds and methods is known in the prior art. More specifically, disinfecting and sanitizing compounds and methods previously devised and utilized for the purpose of disinfecting and sanitizing surfaces and hands are known to consist basically of familiar, expected, and obvious formulations, notwithstanding the myriad of compounds encompassed by the crowded prior art which has been developed for the fulfillment of countless objectives and requirements.

In this respect, the antimicrobial compositions and methods according to the present invention substantially departs from the conventional concepts and formulations and methods of the prior art, and in doing so provides an apparatus primarily developed for the purpose of persistently disinfecting surfaces and persistently sanitizing hands with compositions containing organosilane compounds.

Therefore, it can be appreciated that there exists a continuing need for a new and improved antimicrobial composition and method which can be used for disinfecting surfaces and sanitizing hands with compositions containing organosilane compounds. In this regard, the present invention substantially fulfills this need.

### SUMMARY OF THE INVENTION

In view of the disadvantages inherent in the known types of disinfecting and sanitizing compounds and methods now present in the prior art, the present invention provides improved antimicrobial compositions and methods. As such, the general purpose of the present invention, which will be described subsequently in greater detail, is to provide new and improved antimicrobial compositions and methods which have all the advantages of the prior art and none of the disadvantages.

To attain this, the present invention essentially comprises antimicrobial, hand sanitizing and surface disinfecting compositions which contain at least one of the following antimicrobial agents: Triclosan 0.1-1.0 percent, Triclocarbon 0.01-1.5 percent, Chloroxylenol 0.1-3.0 percent, benzethonium chloride 0.01-1.0 percent, benzalkonium chloride 0.1-1.0 percent, Chlorhexidine gluconate 0.1-4.0 percent, Chlorhexidine digluconate 0.1-4.0, Sodium oxychlorosene 0.1-1.0 percent, Cloflucarban 0.1-1.0 percent, Hexylresorcinol 0.1-2.0 percent, methylbenzethonium chloride 0.01-1.0 percent, phenol 0.01-1.5 percent, o-phenylphenol 0.01-1.5 percent, p-tert-Amylphenol 01-1.5 percent, 2-/benzyl-4-chlorophenol 0.01-1.5 percent, Poloxamer iodine complex 1.0-10.0 percent, Iodine complex 1.0-10.0 percent, Nonylphenoxypoly(ethyleneoxy)ethanoliodine 1.0-10.0 percent, secondary amyltricresols 0.1-1.0 percent, alcohol 50-80 percent Percentages are by weight. Also provided is an antimicrobial organosilane quaternary ammonium compound 0.01-5.0 percent

In addition, the present invention includes a method to reduce the rate of MRSA infections in a hospital wherein a long-acting surface disinfectant is applied to frequent touch points in the hospital and hospital workers apply a persistent hand sanitizer to their hands, the Hospital workers are instructed to apply the surface disinfectant at least monthly to hospital surfaces that are frequently touched by workers, visitors, or patients.

The hospital workers are instructed to apply the hand sanitizer to their hands at the beginning of the work day and reapply at least every 4 hours, additionally, hospital workers are instructed to continue to follow the hospital's hand hygiene guidelines by sanitizing their hands with alcohol sanitizers or washing with soap and water.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one primary embodiment and alternate embodiments of the invention in detail, it is to be understood that the invention is not limited in its application to the details of construction and to the arrangements of the constituents set forth in the following description. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other compounds and methods for carrying out the several purposes of the present invention. It is important, therefore, that the invention be regarded as including such equivalent compositions and methods insofar as they do not depart from the spirit and scope of the present invention.

It is therefore an object of the present invention to provide new and improved antimicrobial compositions and methods which have all of the advantages of the prior art and none of the disadvantages.

It is a further object of the present invention to provide a new and improved antimicrobial composition which contains:

a. an antimicrobial organosilane compound 0.01-5.0 percent by weight; and

b. at least one of the following: phenol 0.01-1.5 percent by weight, o-phenylphenol 0.01-1.5 percent by weight, p-tert-Amylphenol 0.01-1.5 percent by weight, or 2-Benzyl-4-chlorophenol 0.01-1.5 percent by weight.

In addition, it is an object of the invention to provide a method to reduce the rate of infections in a hospital wherein a long-acting surface disinfectant is applied to hard surfaces in the hospital and health care workers (HCWs) apply a persistent hand sanitizer to their hands, the surface disinfectant is applied to surfaces that are frequently touched by HCWs and HCWs are instructed to apply the hand sanitizer to their hands at the beginning of the work day and reapply at least every 4 hours.

For a better understanding of the invention, its operating advantages and the specific objects attained by its uses, reference should be had to the accompanying descriptive matter in which there are described preferred embodiments of the invention.

### DESCRIPTION OF THE PREFERRED EMBODIMENTS

The preferred embodiment of the new and improved antimicrobial compositions and methods embodying the principles and concepts of the present invention will be described.

The present invention, the antimicrobial compositions and methods is comprised of a plurality of constituents. Such constituents are individually configured and correlated with respect to each other so as to attain the desired objective.

This invention relates to antimicrobial compositions comprising alcohol, phenol, phenol complexes, and ammonium chloride complexes, to provide broad-spectrum disinfection, long-acting sanitizing, and very long-acting biostatic activity. These long-acting compositions are used in methods for long-acting surface disinfecting and persistent hand sanitizing in order to reduce healthcare associated infections.

There is a great need to provide more effective antimicrobial compositions to help prevent infections in healthcare. There are an estimated 2,000,000 Healthcare Associated Infections (“HAIs”) annually in the USA. There is a 5 percent or greater chance of acquiring an infection after admission to many hospitals. It is the fourth leading cause of death, with about 100,000 deaths annually due to HAIs. All countries have problems with HAIs, with many countries having greater infection and death rates from infection than the USA.

HAIs are also a financial burden on the healthcare system, with costs estimated at $30-50 billion annually in the United States.

HAIs have become a greater problem in recent years, because some bacteria have become resistant to certain antibiotics. For instance, Staphylococcus aureus has been a common infection in hospitals for many years. In the past, methicillin antibiotics would normally treat the Staph infection successfully. Now, methicillin-resistant Staphylococcus aureus (“MRSA”) is common in hospitals, making it more difficult to treat with antibiotics. Hospital acquired MRSA is the cause of many deaths and increased hospital costs. Several other bacteria have also become resistant to certain antibiotics.

Center for Disease Control (“CDC”) has estimated that about 85 percent of HAIs are caused by Healthcare Workers (“HCWs”) transmitting microorganisms with their hands. Hand hygiene procedures have been established for hospitals. These hand hygiene guidelines require HCWs to sanitize their hands (before and after touching any patient) by washing with soap and water or using an alcohol sanitizer. Studies have shown that HCWs comply with the procedures less than 50 percent of the time. Educational programs improve hand hygiene compliance, but normally for only a short time.

HCWs state that full compliance to Hand Hygiene Guidelines is not practical. It takes too much time to wash hands or use an alcohol sanitizer before and after treating each patient. Plus, frequent use of alcohol sanitizers or washing with soap and water cause the HCWs hands to become dry and cracked. Dry, cracked hands give pathogens a place to hide, making it more difficult to keep hands sanitary. Plus, HCW compliance to Hand Hygiene Guidelines decreases due to the hands hurting when alcohol is used on dry, cracked hands.

Hospitals employ Infection Preventionists in order to try to control the spread of infections. The Infection Preventionists spend a lot of their time trying to convince HCWs to comply with the Hand Hygiene Guidelines. Educational programs improve compliance for a short time, and then HCWs revert back to their old habits. Many Infection Preventionists dislike the role of policing compliance to the guidelines.

Preventing HAIs requires both improved hand hygiene and improved surface disinfection. Unsanitary surfaces in the hospital allows HCWs, patients, or visitors to pick up and transmit bacteria and viruses that cause infection. It is critical to disinfect hospital surfaces, especially those surfaces that are frequently touched by hands of HCWs and patients.

Hospital rooms are cleaned after each patient discharge. Cleaning staff is trained to clean and disinfect. But, the cleaning staff needs to prepare the room in a short period of time in order to be ready for the next patient. It is possible that some surfaces are not disinfected thoroughly.

There is a great need for an improved surface disinfectant, especially for healthcare. This disinfectant needs to have a broad spectrum kill of pathogens with long-acting antimicrobial activity. A persistent, long-acting surface disinfectant continues to be effective between normal cleanings of a surface. Preferably, it continues to kill pathogens for days or weeks. More, preferably the disinfectant would have continuing antimicrobial activity for 30 days or more. Then, it continues to be bacteristatic for another month or longer.

The disinfectant should kill bacteria (gram positive and gram negative), viruses, fungi, mold and mildew. Effectiveness against some spores is very desirable.

The surface disinfectant requires ingredients that are safe for patients and HCWs. For example, hospitals have concerns about using products that contain phenol, due to problems it caused with small babies in the past. CDC has stated that phenol can be used in the same room as a baby, but not in direct contact, so do not use it in incubators or bassinets. Some hospitals prefer not having phenol products anywhere in the hospital for fear that it could be used in the areas that are not appropriate.

All surface disinfectants are required to be US EPA registered before they are allowed to be sold in the United States. Based on toxicity testing of the formulation, EPA has four categories for labeling the product. Category I requires a “Danger” signal word. Category II requires “Warning” on the label. Category III and Category IV both require “Caution” as a signal word for labeling. Preferably, the toxicity of the new formulation is Category III or IV. This indicates to HCWs that the new formulation is safer to use than many hospital disinfectants.

Preferably, the surface disinfectant should not have a strong, offensive odor. Some people object to the strong odor from phenol, chlorine, and other hospital products. When the odor is offensive, there is a tendency to not use it properly or thoroughly. Also, hospitals want to turn over their rooms in a short time after a patient discharge. An offensive odor can delay the turnover time. Phenol and chlorine have strong odors that are offensive to some HCWs.

Preferably, the disinfectant ingredients should not harm the people that apply it. And, the disinfectant should not damage the applicable surface. Chlorine disinfectants are very caustic and can permanently damage some surfaces.

Chlorine disinfectants, despite the offensive odor and corrosiveness, are used in many hospitals because it is one of the few disinfectants that kill C. difficile spores. These sodium chloride disinfectants have a very effective kill, but there is no persistent, long-acting antimicrobial activity.

There is also a great need for an improved hand sanitizer for use in healthcare. Current hospital hand sanitizers have alcohol (normally 60-90 percent ethanol) as the active ingredient. Ethanol is very effective in killing 99.99 percent of pathogens except for spores (specifically C. difficile spores). However, alcohol has no persistent killing, since it no longer effectively kills germs after it dries. Another concern with alcohol is that it damages the HCWs' hands with frequent use. The cracked, dried hands discourage regular use of the alcohol sanitizer and the cracked hands can harbor more pathogens.

The improved hand sanitizer should have broad spectrum antimicrobial activity. It will persistently kill germs for at least an hour, and preferably 4 hours or longer. Preferably, it is alcohol free, so that it does not further damage the hands. It will create a protective layer that stays on the hands, allowing the damaged hands to heal and moisturize. The improved hand sanitizer should be compatible with the use of alcohol sanitizers or soap and water, so that HCWs can comply to Hand Hygiene Guidelines. The improved hand sanitizer's protective, persistent killing layer does not wash off easily by washing with soap and water or by the frequent use of alcohol sanitizers. It should have little odor or a pleasant smell. HCWs will desire to use the improved sanitizer because it helps their hands and allows them to improve patient safety by reducing the number of HAIs. Because the hands are healed, the improved hand sanitizer allows better compliance to the Hand Hygiene Guidelines' required use of alcohol sanitizers or washing with soap and water. CDC and World Health Organization have both stated that there is a need for sanitizers that kill germs persistently. This invention fulfills that need.

There is also a need for a better method to effectively reduce the rate of infections in hospitals by using a long-acting disinfectant in combination with a persistent hand sanitizer. This can be very effective in preventing infections, because when HCWs persistently kill the germs on their hands and persistently kill the germs on the surfaces that their hands touch, it is difficult for HCWs to pick up and transmit infections. This method of using the long-acting antimicrobial compositions does not eliminate the current Hand Hygiene Guidelines or the environmental cleaning procedures, but rather is used in addition to current infection control protocol. This becomes more acceptable to hospitals, because the method can do no harm when current products and procedures continue to be used in addition to the new products.

This invention provides novel antimicrobial compositions which provide multiple actions against bacteria, viruses, fungi, mold and mildew, resulting in a broad-spectrum killing of pathogens. The long-acting sanitizer or disinfectant has an effective initial kill, followed by long-acting antimicrobial, sanitizing activity, and then a very long-acting biostatic, residual activity that inhibits the growth of microorganisms. This persistent, long-acting antimicrobial activity greatly improves the effectiveness of disinfecting surfaces and sanitizing hands, both of which are important to reducing the transmission of infections.

These antimicrobial compositions are novel because they utilize active ingredients that kill microorganisms chemically and other ingredients that kill the microorganisms mechanically by puncturing the cell wall of the organism. The chemical killing ingredient may vary depending on the application. For instance, the chemicals for disinfecting hard surfaces may be stronger and more toxic than a sanitizing chemical that is used on hands.

However, the compositions for the surfaces and hands both combine the chemical killing with a mechanical puncturing kill from the organosilane. The combination of killing chemically and mechanically provides a broader spectrum kill and a long-acting, persistent kill. Pathogens do not acquire resistance to the organosilane because it is a mechanical puncturing of the cell. There is no chemical poisoning to resist. These compositions provide a fast-acting, broad spectrum kill that provides long-term, persistent antimicrobial activity, which is very effective in preventing the transmission of infections.

The surface disinfectant uses phenol, phenol complexes, or their sodium or potassium salts to provide broad-spectrum chemical killing of microorganisms and pathogens. The composition contains at least one phenol or phenol complex chosen from 0.01-1.5 percent phenol (PC code 64001), 0.01-1.5 percent—phenylphenol (PC code 64103), 0.01-1.5 percent p-tert-Amylphenol (PC code 64101), and 0.01-1.5 percent 2-Benzyl-4-chlorophenol (PC code 62201). Preferably, the composition contains 0.1-1.0 percent for each of these components that are chosen. More preferably, the composition contains 0.2-0.6 percent for each of these components chosen.

All composition percentages are percentage by weight unless otherwise stated.

Phenol and phenol complexes have a very broad-spectrum effectiveness, especially when two phenol compounds are used in combination. They provide a longer lasting chemical kill, which dissipates over a period of hours or days, when it remains on the surface.

Combining or suspending these active ingredients in film-forming ingredients that remain on the treated surface will provide longer-acting antimicrobial activity. The film for the phenol complexes can be formed by using 0.1-2.0 percent of 1,3-Propanediamine,N1-(9Z)-9-octadecen-1-yl- or 0.01-2.0 percent polycarboxylic acid, or preferably both. The polycarboxylic acid can be chosen from succinic acid, citric acid, sorbic acid, malic acid and tartaric acid. Preferably, the polycarboxylic acid is 0.1-0.6 percent succinic acid or 0.1-0.6 percent citric acid. Also preferably, the 1,3-Propanediamine,N1-(9Z)-9-octadecen-1-yl- is 0.2-0.8 percent.

P-tert-Amylphenol and/or o-phenylphenol are the phenol complexes that are preferred for this composition. Phenol and 2-Benzyl-4-chlorophenol are not preferred because they have strong odors, which make them less desired by hospital personnel. Also, phenol is not preferred because some hospitals have concerns about the use of phenol near new born children. Phenol was a problem with new born babies in the past, but this was caused by using much higher percentages of phenol than proposed in this invention. 2-Benzyl-4-chlorophenol can also be more toxic and is not preferred for hospital applications.

The mechanical puncturing antimicrobial activity is provided by an organosilane compound (0.01-5.0 percent). The organosilane is capable of forming a very long-term or almost a permanent bond to a surface. The organosilane contributes added antimicrobial activity, biocidal killing, and biostatic actions, which are different from chemical killing with phenolic and other antimicrobial chemicals. The organosilane does not evaporate or release a chemical like a phenol complex when it kills a microorganism. The organosilane material remains present with the same concentration as long as it is bonded to the surface. The organosilane molecule punctures the cell wall of the microorganism, and the positive electrical charge of the organosilane kills the pathogen. The organosilane remains bonded to the surface, positively charged, and will continue to mechanically puncture many pathogen cells to deactivate or kill them. The organosilane works with the other active ingredients to improve the broad spectrum killing, and then continues for weeks or months to inhibit the growth microorganisms.

Preferably, the organosilane is an organosilicon quaternary ammonium compound or mixture thereof; preferably 3-(Trimethoxysilyl)propyl dimethyl octadecyl ammonium chloride (0.1-2.0 percent, PC code 107401), 3-(trihydroxysilyl)propyl dimethyl octadecyl ammonium chloride (0.1-2.0 percent, PC code 107403), 1-Tetradecanaminium,N,N-dimethyl-N-(3-(trimethoxysilyl)propyl)-chloride (0.1-2.0 percent. PC code 107409), or N,N-Didecyl-N-methyl-3-(trimethoxysilyl)propanaminium chloride (0.1-2.0 percent, PC code 169160) and the trisilanol, polysiloxanol and water soluble polysiloxane derivatives thereof for residual bacteristatic inhibition. More preferably, the organosilane is 3-(trimethoxysilyl)propyl dimethyl octadecyl ammonium chloride (0.1-1.0 percent PC code 107401) or 3-(trihydroxysilyl)propyl dimethyl octadecyl ammonium chloride (0.1-1.0 percent, PC code 107403). Most preferably the organosilane is 3-(trihydroxysilyl)propyl dimethyl octadecyl ammonium chloride (0.1-1.0 percent, PC code 107403).

Preferably, the composition includes 50 percent to 80 percent alcohol (chosen from ethanol, methanol, and n-propanol) to provide an initial killing action which is fast and very effective against most microorganisms. More preferably, the composition will contain 60 percent to 72 percent alcohol. Preferably, the chosen alcohol is ethanol. The alcohol dries quickly, but it is no longer effective in killing pathogens after it evaporates or dries. Alcohol has no persistent kill, but it can kill 99.99 percent of most pathogens very fast, before it evaporates. Hospitals prefer a fast-acting disinfectant that dries quickly, so that the disinfected surface can be used without waiting a long time for the disinfectant to dry.

The most preferred surface disinfectant composition will include ethanol, p-tert-Amylphenol, o-phenylphenol, and 3-(trihydroxysilyl)propyl dimethyl octadecyl ammonium chloride. Ethanol provides the initial killing action and enables the disinfectant to dry fast. Next, p-tert-Amylphenol and o-phenylphenol provide longer antimicrobial activity, especially if they are combined with a film-forming ingredient. The longest acting antimicrobial activity is provided by the organosilane, preferably 3-(trimethoxysilyl)propyl dimethyl octadecyl ammonium chloride or 3-(trihydroxysilyl)propyl dimethyl octadecyl ammonium chloride. The organosilane improves the broad spectrum activity and greatly extends the time that the composition is antimicrobial, biostatic or inhibits microbial growth.

The US Environmental Protection Agency reviewed one embodiment of this invention and granted unconditional registration on Dec. 15, 2011. The active ingredients are 61.8 percent ethanol, 0.44 percent o-phenylphenol, 0.33 percent p-tert-Amylphenol, and 0.32 percent 3-(trihydroxysilyl)propyl dimethyl octadecyl ammonium chloride. Film forming ingredients were added to enhance the long-acting antimicrobial activity. It is approved as a “dual action disinfectant”, “Tuberculocidal”, “Kills 99.99 percent Germs on hard non-porous surfaces”, “Kills 99.99 percent MRSA & VRE”, “Bactericidal”, “Viricidal-H1N1 and Rhinovirus”. Tuberculocidal is a claim that is only attained by very powerful disinfectants. Surprisingly, this powerful disinfectant has a low toxicity. EPA registered this formulation as Category III, which requires a signal word of “Caution” on the label. Many disinfectants require signal words of “Warning” or “Danger”, indicating greater toxicity.

Testing has proven that the formulation is very long-acting. Per independent laboratory testing, 99.8 percent kill of E. coli was recorded 4 weeks after a pre-cleaned surface was treated with the formulation. 99.0 percent kill was attained 8 weeks after surface treatment. This surprisingly powerful, long-acting, persistent killing action is not claimed by other disinfectants, indicating that this invention is both effective and innovative.

Testing the same disinfectant composition without the organosilane had 90.0 percent kill at 4 weeks, compared to 99.8 percent with organosilane. This indicates the positive impact on the long-term effectiveness of using the organosilane in this novel composition with phenol complexes.

Long-term effective antimicrobial compositions have been desired by many healthcare experts, including the Center for Disease Control (CDC) and the World Health Organization (WHO), because it is expected to greatly reduce the number of Healthcare Associated Infections.

This formulation with OPP and PTAP has only a slight odor, which is not offensive. Employees and patients should not be opposed to the odor. Other disinfectants with sodium chloride or phenol have much stronger, offensive odors. Disinfectants with strong odors discourage health care workers from using the disinfectant as frequently as needed for controlling pathogens and reducing infection rates.

Some disinfectant applications discourage the use of alcohol. Certain applications have a risk of alcohol abuse or there are concerns about a fire hazards. Prisons, schools, and mental institutions are often concerned about having alcohol on the premises. Some are concerned about someone drinking the product to get alcohol. Other applications have special rules prohibiting alcohol products due to its flammability. For these applications, a composition without alcohol may be required or preferred.

When alcohol is not desired, a non-alcohol formulation is attained by replacing the alcohol with additional water. The phenol complexes and the organosilane is an effective disinfectant without any alcohol. However, it is not as quick killing, or fast drying as the composition that includes alcohol. But, even without alcohol, the formulation containing phenol compounds and the organosilane remains an effective disinfectant with persistent, long-acting antimicrobial activity, especially when combined with a film-forming ingredient.

The non-alcohol composition could also be formulated as a concentrate, where the customer dilutes the composition with water at the time of use. The concentrated formulation would increase the formula percentage of each ingredient by the same ratio as the recommended rate of dilution. Concentrated formulations lower the cost, especially packaging and shipping costs. It also reduces the storage space required. But, there is some risk that if the product is not diluted properly, it can reduce the effectiveness. The concentrated formulation is also more toxic, while in the concentrated form, and this causes some additional handling and employee protection concerns.

The surface disinfectant composition is not a detergent or cleaner. The surface disinfectant is more effective when the surfaces are cleaned prior to applying the disinfectant. The organosilane compound attaches better and continues to be active for a longer time when the surface has been pre-cleaned. Additionally, CDC recommends that healthcare surfaces be cleaned prior to disinfection.

The disinfectant compositions can be applied as a spray or a wipe. Preferably, the compositions are ready-to-use and do not require dilution.

A more effective, persistent Hand Sanitizer is composed by antimicrobial chemicals and organosilane technology, similar to the Surface Disinfectant. Combining the mechanical puncturing killing, long-lasting antimicrobial organosilane with chemical antimicrobial killing, improves the effectiveness and persistence of a hand sanitizer. These same formulations may also be effective as an antiseptic for application to the skin in locations other than the hands.

Antimicrobial compositions for hand hygiene are more effective by killing microorganisms persistently both chemically and mechanically. The organosilane attaches to the skin to provide a hydrophobic, protective layer to the skin and a long-term killing by mechanically puncturing the cell wall of the microorganism to kill the pathogen. The hand sanitizing compositions also contain chemical sanitizing components chosen from antimicrobial agents that are acceptable for use on hands.

The chemical antimicrobial for the hand sanitizer is chosen by using at least one of the following active ingredients: Triclosan 0.1-1.0 percent, Triclocarbon 0.01-1.5 percent, Chloroxylenol 0.1-3.0 percent, benzethonium chloride 0.01-1.0 percent, benzalkonium chloride 0.1-1.0 percent, chlorhexidine gluconate 0.1-5.0 percent, chlorhexidine digluconate 0.1-5.0 percent, methylbenzethonium chloride 0.1-1.0 percent, PTAP 0.01-1.5 percent, Phenol 0.01-1.5 percent, Sodium oxychlorosene 0.1-1.0 percent, Poloxamer iodine complex 0.1-10.0 percent, Cloflucarban 0.1-1.0 percent, Hexylresorcinol 0.1-1.0 percent, iodine complex 1.0-10.0 percent, Nonylphenoxypoly (ethyleneoxy) ethanoliodine 0.1-10.0 percent, secondary amyltricresols 0.1-1.0 percent, alcohol 50.0-80.0 percent. These are active ingredients that are effective sanitizers when properly formulated and that kill microorganisms chemically. The hand sanitizer contains no OPP because it can harm the skin.

Preferably, the chemical antimicrobial is chosen by using at least one the following active ingredients: Triclosan 0.1-1.0 percent, Triclocarbon 0.01-1.5 percent, Chloroxylenol 0.1-3.0 percent, benzethonium chloride 0.01-1.0 percent, benzalkonium chloride 0.1-1.0 percent, chlorhexidine digluconate 0.1-5.0 percent, chlorhexidine gluconate 0.1-5.0 percent, Phenol 0.01-1.5 percent and, alcohol 50.0-80.0 percent.

More preferably, the chemical antimicrobial is Triclosan because it has persistent kill and does not deactivate with the use of soap.

For pre-surgical applications, it is preferred that the chemical antimicrobial is chosen from chlorhexidine gluconate or chlorhexidine digluconate.

Preferably, the chemical antimicrobial is suspended in a lotion that forms a polymeric, hydrophobic layer on the hands. This enables the lotion to persistently kill pathogens for 4 hours or longer, unless the layer is removed. Preferably, this layer is formulated to not wash off easily with soap and water or alcohol sanitizers, providing a persistent killing action between the frequent hand washings. After the lotion is applied to the hands, the layer helps protect HCWs' hands from the harsh effects of frequent use of soap and water or alcohol sanitizers. This protective layer allows dry, cracked hands to heal and moisturize. Healthcare workers are able to better comply with the frequent sanitizing requirements of hospital Hand Hygiene Guidelines when their hands are healthy. HCWs' hands do not hurt when using an alcohol sanitizer because the alcohol will touch the protective layer on the hands and does not touch the skin of the hands.

Preferably, the polymeric, hydrophobic layer for suspending the antimicrobial chemical is an emulsion comprised of a mixture of Methyl, Ethyl, Propyl, and Butyl Parabenzene and USP White Wax in combination with an acrylic carbomer, such as Carbopol 934-P. This wax blend can be combined with a nonionic surfactant blend to attain a smooth, non-granular lotion that adheres to the hands and does not wash off easily with an alcohol sanitizer or with soap and water.

The lotion compositions also contain an antimicrobial, organosilane quaternary ammonium compound (0.01-5.0 percent), which remains on the skin and substantive to it. The organosilane helps kill, eliminate, inhibit, or reduce the growth of bacteria, viruses and fungi that are present on the hands and prevent or reduce future contamination by their presence and substantive character. This persistent, long-acting antimicrobial, bacteristatic activity helps prevent the transmission of pathogens to hospital patients or other susceptible people.

Preferably, the organosilane is chosen from the group consisting of 3-(Trimethoxysilyl)propyl dimethyl octadecyl ammonium chloride (0.1-2.0 percent, PC code 107401), 3-(trihydroxysilyl)propyl dimethyl octadecyl ammonium chloride (0.1-2.0 percent, PC code 107403), 1-Tetradecanaminium,N,N-dimethyl-N-(3-(trimethoxysilyl)propyl)-chloride (0.1-2.0 percent, PC code 107409), or N,N-Didecyl-N-methyl-3-(trimethoxysilyl)propanaminium chloride (0.1-2.0 percent, PC code 169160). More preferably, the organosilane is 3-(Trimethoxysilyl)propyldimethyloctadecyl ammonium chloride or 3-(trihydroxysilyl)propyl dimethyl octadecyl ammonium chloride.

Preferably, the organosilane content is 0.1-2.0 percent. Optionally, the composition may also contain 50.0-80.0 alcohol (preferably ethanol). Alcohol provides quick killing of pathogens and also enables the lotion's hydrophobic layer to dry on the hands in less time. Without alcohol, the lotion is composed of more than 70 percent water and it requires about 45 to 60 seconds drying on the hands. The alcohol content can reduce the drying time to less than 30 seconds, which can be preferred by healthcare workers busy schedule. However, alcohol has no persistent kill. When the alcohol dries, there is no residual antimicrobial activity from the alcohol. Therefore, if alcohol is used in the formulation, the composition preferably includes at least one of the antimicrobial chemicals listed previously, in order to attain a persistent chemical kill in addition to the organosilane persistent, mechanical killing.

The organosilane forms an added protective layer for the skin, by attaching to the stratum corneum, the outermost layer of the epidermis. It is theorized that the organosilane layer helps the lotion layer adhere to the skin longer with the suspended antimicrobial chemical, providing a more effective, longer-lasting chemical antimicrobial activity. This outer layer of skin is sloughed off, which gradually reduces the lotion and organosilane layer on the skin. This results in the organosilane and the lotion antimicrobial activity becoming less effective after a period of time. Therefore, it is recommended that the hand sanitizer be reapplied every 3 to 4 hours. It can be reapplied more often, but every 4 hours is adequate in order to maintain good antimicrobial activity.

Government regulators often prefer the use of alcohol and are reluctant to approve hand sanitizer formulations with more than one active chemical antimicrobial ingredient. In this case, when alcohol is the preferred chemical antimicrobial, an alternative hand sanitizing formulation would include alcohol, preferably ethanol, with the organosilane, preferably 3-(Trimethoxysilyl)propyldimethyloctadecyl ammonium chloride or 3-(trihydroxysilyl)propyl dimethyl octadecyl ammonium chloride. Preferably, this is formulated in a lotion that forms a protective, polymeric, hydrophobic layer on the hands. This layer helps protect the hands from the harsh effects of frequent alcohol sanitizing. Preferably, the polymeric, hydrophobic layer is an emulsion comprised of a mixture of Methyl, Ethyl, Propyl, and Butyl Parabenzene and USP White Wax in combination with an acrylic carbomer, such as Carbopol 934-P. This wax blend can be combined with a nonionic surfactant blend to attain a smooth, non-granular lotion that adheres to the hands and does not wash off easily with an alcohol sanitizer or with soap and water.

Alternatively, the organosilane does not need to be attached to the skin, but rather be attached to a bead, powder, or other material, which is then suspended in the polymeric layer on the hands. Silica, calcium carbonate, talc, or other powders and beads can be treated with organosilane, which is then added to the composition to provide persistent, long-acting antimicrobial, bacteristatic activity.

The hand sanitizing composition may also include water, fragrances, emollients, surfactants, aloe, chelating agents, vitamins such as vitamin E, and essential oils in order to aid the formulating of lotion that feels good on the hands, has a pleasant fragrance, and helps moisturize or heal hands that have been damaged by frequent hand washing.

This invention also provides a method of using the novel, long-acting antimicrobial compositions for hard surfaces along with a novel, persistent hand sanitizer to greatly reduce the rate of infections in hospitals. Both hand sanitizing lotion and surface disinfectant contain an organosilane and antimicrobial chemicals to attain a long-term, broad-spectrum killing of microorganisms.

This method incorporates and encourages better compliance to current hospital protocol for infection control. Normal hospitals rules require HCWs to comply to Hand Hygiene Guidelines as stated by CDC. Hospitals also have surface cleaning and disinfecting requirements which are normally done by their Environmental Services (Housekeeping) department.

The method requires the use of the novel surface disinfectant in addition to using the novel hand sanitizing lotion. Both the hand sanitizing lotion and surface disinfectant are antimicrobial for a long time because one or both contain an organosilane, preferably 3-(trihydroxysilyl)propyl dimethyl octadecyl ammonium chloride or 3-(Trimethoxysilyl)propyl dimethyl octadecyl ammonium chloride for residual bacteristatic inhibition. The organosilane enables the hand sanitizer and surface disinfectant to have longer antimicrobial activity, especially when formulated with other active ingredients (preferably chosen from alcohol, phenolic compounds, and quaternary ammonium chlorides) that kill pathogens chemically. In addition, preferably the hand sanitizer provides a hydrophobic layer on the hands, protecting the skin from the harsh, frequent hand washing (or alcohol washes) that are required for Health Care Workers.

CDC estimated that 85 percent of HAIs are transmitted by HCW hands. Persistent, long-term killing of pathogens on HCWs' hands and long-term killing of microorganisms on the surfaces that the HCW's hands touch makes it difficult for HCWs to transmit infections to patients. This is especially effective when the persistent sanitizer and disinfectant products are used in addition to the normal CDC Hand Hygiene Guidelines.

This method instructs HCWs to apply persistent hand sanitizing lotion at the start of their workday, after washing and drying their hands. Then, reapply the lotion at least every 3 to 4 hours. This hand sanitizing lotion is used in addition to the hospital's Hand Hygiene Guidelines. The Guidelines normally require HCWs to use alcohol sanitizers or wash with soap and water before and after treating each patient.

HCWs compliance to the Guidelines is acknowledged to be poor, sometimes less than 50 percent compliance. Dry, cracked hands are often stated as the reason for poor compliance. The hand sanitizing lotion protects and helps to heal the dry, cracked hands, allowing HCWs to improve their compliance to the Guidelines. The hands no longer hurt when using alcohol or washing with soap and water, because the hands are protected by the polymeric, hydrophobic layer on their hands from the lotion.

Hospitals can be confident in using the sanitizing lotion because the method of use only adds another layer of protection. The lotion is used in addition to the current hand hygiene requirements. The lotion provides a persistent kill in between normal hand hygiene. Since current protocol is maintained, there is no concern that the use of the lotion will be a step backwards in the fight against pathogens. The addition of the lotion helps heal hands, increasing the compliance to the Guidelines and the effectiveness of the Hand Hygiene Guidelines.

The method also requires the monthly use of a long-acting surface disinfectant, preferably with the long-acting organosilane antimicrobial activity. Hospital personnel (normally housekeeping or environmental services) are instructed to apply the surface disinfectant to frequent touch points in the hospital. Housekeeping personnel normally understand the term “touch points” to include surfaces that the HCWs, patients, or visitors frequently touch. This includes beds, bed rail/release, door handles, door and frame, carts, light switch, telephone, TV remote, call buttons, elevator buttons, hall railings, carts, table tops, countertops, window sill, chairs, walkers, gurneys, wheelchairs, toilet, bathroom surfaces, lamps, bedside equipment, cables, blood pressure cuffs, computer, keyboard, nurse station surfaces, clipboards, etc. It does not include floors, ceilings or other surfaces that are not routinely touched.

It is recommended to apply the disinfectant to hard surface touch points throughout the hospital at least monthly. Preferably, nursing stations should be treated weekly, because they are high traffic areas. Preferably, the disinfectant should be applied after each terminal clean of a patient room. Terminal clean is the cleaning of a patient room after a patient is discharged and before the next patient uses the room.

The organosilane surface disinfectant composition is not a detergent or cleaner. This method for using the surface disinfectant is more effective when the surfaces are cleaned prior to applying the disinfectant. The organosilane compound attaches better and continues to be active for a longer time when the surface has been pre-cleaned. The disinfectant with the organosilane has extended, long-acting, residual antimicrobial activity, which results in a very effective reduction of the transmission of infections.

The use of both the persistent hand sanitizing lotion and long-acting disinfectant in accordance with this method is expected to reduce the rate of HAIs by at least 25 percent. In the USA, this would result in about 500,000 fewer HAIs, 25,000 fewer deaths annually. In addition, USA healthcare costs are reduced by about $10 billion. Worldwide, dramatic healthcare improvement is possible by using this method of persistently sanitizing hands and surfaces in hospitals.

Third party testing present invention produced surprising and unexpected results, results which were unobvious in light of the prior art. With respect to the disinfectant, testing was done by Antimicrobial Test Laboratories (ATL), an independent lab that is qualified to do testing for the EPA. ATL tested Germ Pro Surface Disinfectant Plus, the present invention, to determine residual antimicrobial activity. Pre-cleaned surfaces were sprayed with the disinfectant and allowed to dry. The surfaces were inoculated with S. aureus at time zero, 5 days, 10 days, and 30 days. Even after 30 days, there was a kill rate of 99.97 percent. ATL test report is available. In order to attain these results, it is important to apply the Germ Pro coating to a clean surface and allow it to dry. This requires a two step process of cleaning, then disinfecting. A combined cleaner/sanitizer (like the Avery '943 patent) is popular with hospitals because less labor is required. However, a cleaner/sanitizer can not attain a residual kill rate of 99.97 percent after 30 days. Germ Pro is the only EPA registered disinfectant that kills Tuberculosis, MRSA, VRE, bacteria, and viruses and has a kill rate of 99.97 percent after 30 days. This persistent killing of germs helps prevent hospital acquired infections (HAIs).

The disinfectant and the hand hand sanitizer of the present invention were tested by Select Medical, the largest operator of long-term acute care (LTAC) hospitals. LTAC hospitals are known to have very high rates of HAIs, because they treat very sick, vulnerable patients. Select agreed to trial Germ Pro's Persistent Action Plan in 4 of their 110 hospitals, starting in May 2013. These hospitals all had high infection rates, especially with Clostridium difficile. C. difficile is a spore that is very difficult to kill and is major problem in most hospitals. Patients get terrible diarrhea and many die. Select has reported to us that the trial was a tremendous success, with all 4 hospitals decreasing their infection rates by more than 60 percent in the first 3 months. They plan to install Germ Pro in all 110 hospitals.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent is as follows:

1. An antimicrobial composition which contains:
a. an antimicrobial organosilane compound 0.01-5.0 percent by weight; and
b. an additive chosen from the class of additives consisting of phenol 0.01-1.5 percent by weight, o-phenylphenol 0.01-1.5 percent by weight, p-tert-Amylphenol 0.01-1.5 percent by weight, and 2-Benzyl-4-chlorophenol 0.01-1.5 percent by weight, the composition having antimicrobial activity for at least 30 days after application to a pre-cleaned hard surface.

2. The composition of claim 1, which also contains alcohol 50-80 percent by weight, chosen from the class of alcohols consisting of ethanol, methanol, and propanol.

3. The composition of claim 1, in which the antimicrobial organosilane compound is selected from the group consisting of a 3-(Trimethoxysilyl)propyl dimethyl octadecyl ammonium chloride, 3-(trihydroxysilyl)propyl dimethyl octadecyl ammonium chloride, 1-Tetradecanaminium,N,N-dimethyl-N-(3-(trimethoxysilyl)propyl)-chloride, and N,N-Didecyl-N-methyl-3-(trimethoxysilyl)propanaminium chloride.

4. The composition of claim 3, in which the organosilane compound is 0.01-1.5 percent by weight 3-(trihydroxysilyl)propyl dimethyl octadecyl ammonium chloride.

5. The composition of claim 1, in which o-phenylphenol is the only ingredient chosen from the class of additives consisting of phenol 0.01-1.5 percent by weight, o-phenylphenol 0.01-1.5 percent by weight, p-tert-Amylphenol 0.01-1.5 percent by weight, and 2-Benzyl-4-chlorophenol 0.01-1.5 percent by weight.

6. The composition of claim 1, in which p-tert-Amylphenol is the only ingredient chosen from the class of additives consisting of phenol 0.01-1.5 percent by weight, o-phenylphenol 0.01-1.5 percent by weight, p-tert-Amylphenol 0.01-1.5 percent by weight, and 2-Benzyl-4-chlorophenol 0.01-1.5 percent by weight.

7. The composition of claim 1, which contains at least two of the additives chosen from the additives consisting of phenol 0.01-1.5 percent by weight, o-phenylphenol 0.01-1.5 percent by weight, p-tert-Amylphenol 0.01-1.5 percent by weight, and 2-Benzyl-4-chlorophenol 0.01-1.5 percent by weight.

8. The composition of claim 7, which contains o-phenylphenol and p-tert-Amylphenol as the only additives from the additives consisting of phenol 0.01-1.5 percent by weight, o-phenylphenol 0.01-1.5 percent by weight, p-tert-Amylphenol 0.01-1.5 percent by weight, and 2-Benzyl-4-chlorophenol 0.01-1.5 percent by weight.

9. The composition of claim 1, which also contains 0.1-2.0 percent by weight of 1,3-Propanediamine, N1-(9Z)-9-octadecen-1-yl-.

10. The composition of claim 1 which also contains 0.01-1.5 percent by weight polycarboxylic acid, selected from the group consisting of succinic acid, citric acid, sorbic acid, malic acid, and tartaric acid.

11. The composition of claim 1 which forms a film when applied to a surface.

12. The composition of claim 9 which forms a film when applied to a surface.

13. The composition of claim 10 which forms a film when applied to a surface.

14. The composition of claim 1, which contains no phenol and contains no 2-Benzyl-4-chlorophenol.

15. The composition of claim 2, which disinfects pre-cleaned hard surfaces by killing 99.99 percent of germs, including turberculosis, MRSA, VRE and viruses.

16. An antimicrobial, hand sanitizing composition which contains:
a. Ethanol 50.0-80.0 percent by weight; and
b. a treated particle with an antimicrobial organosilane compound attached to it 0.01-5.0 percent by weight.

17. A composition of claim 16, which also contains a polymeric emulsion which provides a hydrophobic, protective layer on the hands.

18. A composition of claim 17, wherein the polymeric emulsion comprises a mixture of Methyl, Ethyl, Propyl, and Butyl Parabenzene and USP White Wax.

19. A composition of claim 16, in which the treated particle is a powder chosen from the group consisting of zinc oxide, silica, calcium carbonate, and talc.

20. A composition of claim 16, in which the treated particle is a bead chosen from the group consisting of zinc oxide, silica, calcium carbonate, and talc.

21. The composition of claim 16, in which the antimicrobial organosilane compound is selected from the group consisting of a 3-(Trimethoxysilyl)propyl dimethyl octadecyl ammonium chloride, 3-(trihydroxysilyl)propyl dimethyl octadecyl ammonium chloride, 1-Tetradecanaminium,N,N-dimethyl-N-(3-(trimethoxysilyl)propyl)-chloride, and N,N-Didecyl-N-methyl-3-(trimethoxysilyl)propanaminium chloride.

22. The composition of claim 21, in which the selected antimicrobial organosilane compound is 3-(trihydroxysilyl)propyl dimethyl octadecyl ammonium chloride.

23. An antimicrobial, hand sanitizing composition which contains:
a. An antimicrobial agent chosen from the class of antimicrobial agents consisting of Triclosan 0.1-1.0 percent, Triclocarbon 0.01-1.5 percent, Chloroxylenol 0.1-3.0 percent, benzethonium chloride 0.01-1.0 percent, benzalkonium chloride 0.1-1.0 percent, Chlorhexidine gluconate 0.1-4.0 percent, Chlorhexidine digluconate 0.1-4.0, Sodium oxychlorosene 0.1-1.0 percent, Cloflucarban 0.1-1.0 percent, Hexylresorcinol 0.1-2.0 percent; and
b. a treated particle chosen from the group consisting of beads, powder and other particle with an antimicrobial organosilane compound attached to it 0.01-5.0 percent by weight.

24. A composition of claim 23, which also contains a polymeric emulsion which provides a hydrophobic, protective layer on the hands.

25. A composition of claim 24, wherein the polymeric emulsion comprises a mixture of Methyl, Ethyl, Propyl, and Butyl Parabenzene and USP White Wax.

26. The composition of claim 23, in which the antimicrobial organosilane compound is selected from the group consisting of a 3-(Trimethoxysilyl)propyl dimethyl octadecyl ammonium chloride, 3-(trihydroxysilyl)propyl dimethyl octadecyl ammonium chloride, 1-Tetradecanaminium,N,N-dimethyl-N-(3-(trimethoxysilyl)propyl)-chloride, and N,N-Didecyl-N-methyl-3-(trimethoxysilyl)propanaminium chloride.

27. The composition of claim 23, in which the antimicrobial organosilane compound is 3-(trihydroxysilyl)propyl dimethyl octadecyl ammonium chloride.

28. A composition of claim 23, in which the treated particle, bead, or powder is chosen from the group consisting of zinc oxide, silica, calcium carbonate, and talc.

29. A method to reduce the rate of infections in a hospital wherein a long-acting surface disinfectant is applied to pre-cleaned hard surfaces in the hospital and health care workers apply a persistent hand sanitizer to their hands, wherein the surface disinfectant is an antimicrobial composition which contains:
a. alcohol 50.0-80.0 percent by weight, chosen from the class of alcohols consisting of ethanol, methanol, and propanol; and
b. an additive chosen from the class of additives consisting of phenol 0.01-1.5 percent by weight, o-phenylphenol (OPP) 0.01-1.5 percent by weight, p-tert-Amylphenol (PTAP) 0.01-1.5 percent by weight, and 2-Benzyl-4-chlorophenol 0.01-1.5 percent by weight; and
c. an antimicrobial organosilane compound 0.01-5.0 percent by weight, and selected from 3-(Trimethoxysilyl)propyl dimethyl octadecyl ammonium chloride, 3-(trihydroxysilyl)propyl dimethyl octadecyl ammonium chloride, 1-Tetradecanaminium,N,N-dimethyl-N-(3-(trimethoxysilyl)propyl)-chloride, and N,N-Didecyl-N-methyl-3-(trimethoxysilyl)propanaminium chloride; and
d. water.

30. The method of claim 29, wherein the hand sanitizer is an antimicrobial composition which contains:
a. an antimicrobial agent chosen from the class of antimicrobial agents consisting of Triclosan 0.1-1.0 percent, Triclocarbon 0.1-1.5 percent, Chloroxylenol 0.1-3.0 percent, benzethonium chloride 0.01-1.0 percent, benzalkonium chloride 0.1-1.0 percent, Chlorhexidine gluconate 0.1-4.0 percent, Chlorhexidine digluconate 0.1-4.0, Sodium oxychlorosene 0.1-1.0 percent, Cloflucarban 0.1-1.0 percent, Hexylresorcinol 0.1-2.0 percent, methylbenzethonium chloride 0.01-1.0 percent, phenol 0.01-1.5 percent, p-tert-Amylphenol 0.01-1.5 percent, Poloxamer iodine complex 1.0-10.0 percent, Iodine complex 1.0-10.0 percent, Nonylphenoxypoly(ethyleneoxy)ethanoliodine 1.0-10.0 percent, and secondary amyltricresols 0.1-1.0 percent, Percentages are by weight; and
b. a treated particle chosen from the group consisting of a beads, powder and other particle with an antimicrobial organosilane compound attached to the treated particle 0.01-5.0 percent by weight.

31. The method of claim 30, wherein the hand sanitizer forms a hydrophobic layer on the hands that is not easily removed by washing the hands with soap and water and has antimicrobial activity for at least 4 hours.

32. The method of claim 30, wherein the hand sanitizer increases the moisture of the skin within 10 days of daily application.

33. The method of claim 30, wherein HCWs are instructed to apply the surface disinfectant to touch point surfaces at least monthly and to apply the hand sanitizer at the start of the work day and reapply at least every 4 hours.
